(19) United States
(12) Patent Application Publication
(10) Pub. No.: US 2018/0183482 A1
(43) Pub. Date: Jun. 28, 2018

(54) INTEGRATED WIRELESS COMMUNICATION SENSING AND MONITORING SYSTEM

(71) Applicant: 3M INNOVATIVE PROPERTIES COMPANY, St. Paul, MN (US)

(72) Inventor: Ernesto M. Rodriguez, Jr., Austin, TX (US)

(21) Appl. No.: 15/736,074

(22) PCT Filed: Jun. 15, 2016
(86) PCT No.: PCT/US2016/037523

§ 371 Date: Dec. 13, 2017

Related U.S. Application Data
(60) Provisional application No. 62/180,417, filed on Jun. 16, 2015.

(51) Int. Cl. H04B 1/40; H04Q 9/00

(52) U.S. Cl. CPC H04B 1/40; H04Q 9/00

(57) ABSTRACT

A data communication system, comprises a housing mountable to an enclosure, the housing including a transceiver configured to communicate with a network outside of the enclosure, a monitoring device attachable to the housing that provides data related to a real-time condition within the enclosure, control electronics to control sensor data communication via the transceiver, and a power source to power the transceiver on an at least intermittent basis.

### BACKGROUND

Machine to machine communication is becoming increasingly important to the energy, communications, and security markets, among others. Supervisory Control and Data Acquisition (SCADA) systems used in those industries rely on inputs from remotely located sensors to function properly. SCADA systems can also output signals to actuate remote equipment in the field. A sizeable portion of that equipment is located in enclosures and underground, and providing wireless communications between these locations can be a challenge.

Current methods used to locate enclosure and underground events or conditions are still slow and labor intensive.

### SUMMARY OF THE INVENTION

In one aspect of the invention, a data communication system comprises a transceiver disposed on an enclosure, such as an underground, grade level, or above ground enclosure. The transceiver includes a housing, the housing mountable to the entrance port, wherein the transceiver is configured to communicate with a network outside of the enclosure. The data communication system also includes a monitoring device, such as a sensor, disposed in the enclosure that provides data related to a real-time condition within the enclosure. The data communication system also includes control electronics to control sensor data communication via the transceiver. In an aspect of the invention, the data communication system also includes a power source within the housing to power the transceiver.

In another aspect, the sensor detects at least one of: temperature, combustible materials or byproducts of combustion, mechanical strain, mechanical movement, humidity, soil condition, pressure, hazardous atmosphere, liquid flow, leakage, component end-of-life or lifetime, personnel presence, physical state, light level, and vibration.

In another aspect, the transceiver unit includes a hardened above ground antenna and radio. In another aspect, the transceiver is configured to send sensor information upstream to a node or cloud server above ground. In a further aspect, the sensor data comprises one or more of periodic status notification and asynchronous alarm notification.

In another aspect, the entrance port comprises a manhole cover. In a further aspect, the transceiver housing is secured to the manhole cover and a portion of the transceiver housing extends through a hole formed in the entrance cover. In yet another aspect, the transceiver housing portion extending through the hole formed in the entrance cover is substantially flush with a top surface of the entrance cover.

In another aspect, the enclosure comprises an underground vault. In a further aspect, the enclosure comprises a grade level or above-ground enclosure.

The above summary of the present invention is not intended to describe each illustrated embodiment or every implementation of the present invention. The figures and the detailed description that follows more particularly exemplify these embodiments.

### BRIEF DESCRIPTION OF THE DRAWINGS

The invention will be described hereinafter in part by reference to non-limiting examples thereof and with reference to the drawings, in which:

FIG. 1 is a partial cut away view of a data communication system according to an aspect of the invention.

FIG. 2 is a partial cut away view of a data communication system mounted to a manhole cover according to another aspect of the invention.

FIGS. 3A and 3B are alternative views of a data communication system mounted to an electronics cabinet according to other aspects of the invention.

FIG. 4 is a side view of a data communication system according to another aspect of the invention.

FIG. 5 is a flow chart of an example communication process according to another aspect of the invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION OF EMBODIMENTS

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “forward,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

In one aspect of the present invention, a data communication system includes an integrated wireless communication network module which has a communication component or gateway, a microcontroller or microprocessor unit, a power source, and electronics that can be built into or attached onto (via an interface connector panel) an enclosure, such as an IP68 rated enclosure or equipment cabinet. The data communication system can further include an integrated sensor and/or a port or interface for connecting/attaching one or more (additional) sensors directly to the data communication system. Optionally, the data communication system also includes built-in GPS capability. The module can be molded or machined to be made out of a thermoplastic or other types of molded materials. The integrated data communication system is designed to be modular and flexible that can connect several types of sensors as required. In some aspects the sensors can be remotely configurable via software updates received by the data communication system. In one aspect, the integrated data communication system includes sensor dongles that can extend the sensor heads to various places in an underground environment. In another aspect, the integrated data communication system includes sensors that can extend at grade level. Moreover, while the integrated data communication system can operate in enclosures such as manholes and vaults, it can also be a stand-alone device that can be utilized in various applications such as monitoring traffic, bridge acoustics, and irrigation mapping.

In particular, in one aspect, the transceiver includes a physically robust antenna and radio. This antenna/transceiver can take a combination of signals from the monitoring device(s)/sensor(s) which provide real-time data regarding environmental, component, and other conditions within the underground enclosure. The transceiver can communicate with above-ground network elements such as wireless access points, mobile radio cells, and private radios. The transceiver can be disposed or embedded in a raised or flush-mounted structure. In addition, multiple antennas (e.g., antennas transmitting/receiving WiFi, GPS, mobile radio, etc. signals) can be provided in a single robust structure.

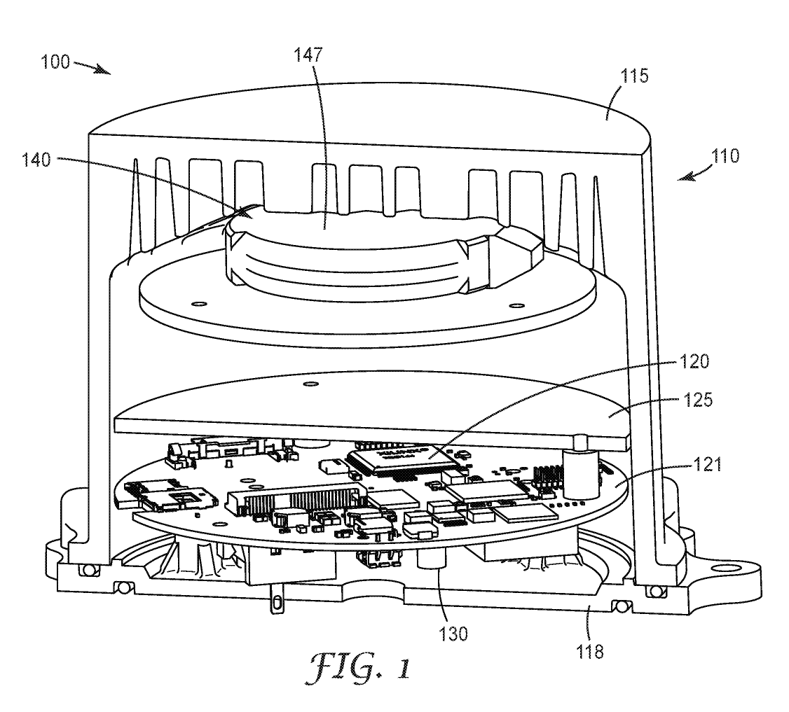

FIG. 1 shows one aspect of the present invention, a data communication system 100. In this aspect, the data communication system 100 is an underground data communication system. The communications system 100 is disposed in an exemplary underground enclosure, such as an underground vault. In this example implementation, the vault includes a variety of electrical equipment.

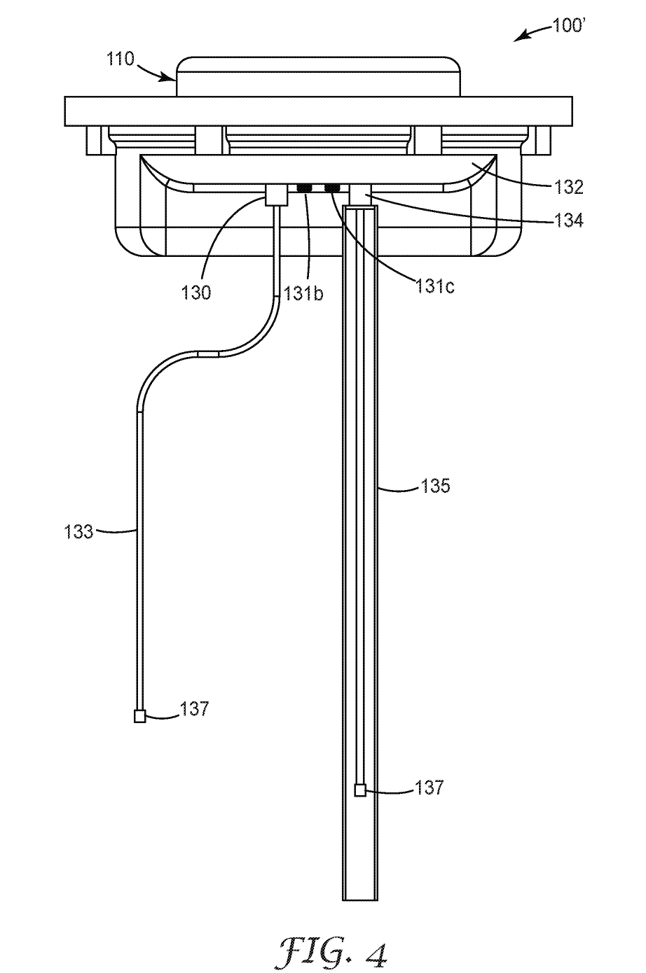

The data communication system comprises a transceiver 140 configured to communicate with a network outside of the enclosure. The transceiver 140 is mounted within a housing 110 that is mountable to an entrance port to an enclosure or to an equipment cabinet. The housing can include a cover or top portion 115 and a bottom portion 118. The data communication system includes an antenna 147 and a radio. The data communication system also includes a micro controller or microprocessor 120 to control communication operations, content and timing. In addition, the data communication system also includes one or more monitoring devices or sensors 130, which can be integrated within the housing or can be mounted via a separate interface board (see e.g., FIG. 4) that is attachable to the housing that provides data related to a real-time condition within the enclosure. As a fully integrated unit, the data communication system can also include a power source (such as a battery, a ferroelectric device, a supercapacitor, a power harvester, or a photovoltaic device) to power the transceiver 140 on an at least intermittent basis.

In one aspect, the transceiver 140 can be mounted/designed in a modular way as to have the flexibility to install various additional sensors in a variety of packages for different applications.

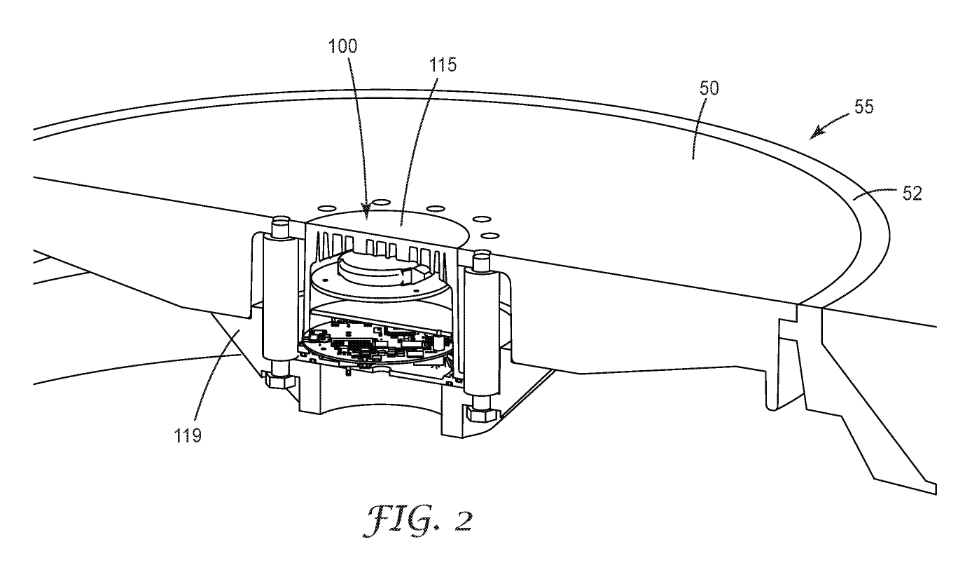

As shown in FIG. 2, the enclosure or vault can be accessed from above ground via a portal or entrance port 55 that includes a manhole cover 50, which can be formed from a metal or non-metal, and can have a conventional circular shape. In a one aspect, the manhole cover 50 can be mounted on a ring, frame or flange structure 52 of the entrance port 55. In addition, the top portion (cover 115) of the housing 110 of transceiver 140 can be designed to be substantially flush with a top surface of entrance cover 50. In this manner, the risk of damage to the transceiver from outside elements is reduced. In some aspects, a mounting structure 119 can be used to secure the data communication system 100 to the manhole cover 50 from inside the enclosure.

In this aspect, the vault can be constructed as a conventional underground vault, commonly used by electric, gas, water, and/or other utilities. However, in alternative aspects, the data communication system 100 can be utilized in another type of underground enclosure or similar structure, such as a manhole, basement, cellar, pit, shelter, pipe, or other underground enclosure.

As mentioned, the data communication system also includes at least one monitoring device or sensor which can monitor a physical condition of the vault or of the components or equipment located in the vault or equipment cabinet. Such conditions would normally be difficult to gather or assess from above-ground or outside of the cabinet. As described herein, the data communication system can provide a communication infrastructure to relay condition information to an above ground/outside network or SCADA, without having a service technician physically enter the vault/cabinet to determine those conditions. In some cases, the data communication system can provide a means of wirelessly communicating to and from a structure that is constructed in a manner that would otherwise prevent direct wireless communications to and from the interior portion of the structure.

Thus, it is contemplated that the monitoring device or sensor 130, such as shown in FIG. 4, can comprise one or more of the following sensors: temperature, combustible materials or byproducts of combustion, mechanical strain, mechanical movement (e.g. revolutions per minute), humidity, soil condition (acidity, moisture content, mineral content), pressure, hazardous atmosphere, liquid flow, leakage, component end-of-life or lifetime (e.g., a cathodic protection sensor), personnel presence (e.g., has someone entered the enclosure), physical state (e.g., is the enclosure open or closed, is the door open or closed, is a switch or valve open or closed, has an item been tampered with), light sensor, vibration (seismic, tampering). For example, the data communication system can be implemented with a series of environmental sensors, such as gas (e.g., CH4, H2S, CO, etc.), water, and temperature (or humidity). Each sensor can have a hardware programmable unique I2C address. In addition, the sensors can each have one or more separate probes that extend into the environment (e.g., they can be sealed for continuous submersion in some applications).

In another aspect of the invention, data is communicated from the sensor or monitoring device to a network or SCADA located outside the enclosure. This communication can be accomplished via transceiver 140. The data communication system can interpret monitoring device/sensor information to determine environmental conditions such as the presence of hazardous gases, moisture, dust, chemical composition, corrosion, pest presence, and more. Further, the data communication system can send aggregated information such as periodic status or asynchronous alarm notifications upstream to another aggregation node or cloud server above ground. The data communication system can also respond to messages sent to it by an upstream aggregation node or cloud (e.g., SCADA) service. Typical commands from an upstream node or cloud service can include “transmit status,” perform action,” “set configuration parameter,” “load software,” etc.

In several aspects, the transceiver 140 comprises an environmentally hardened antenna 147 which is coupled to a radio which communicates with widely available above-ground wireless communications networks such as WiFi, WiMax, mobile telephone (3G, 4G, LTE), private licensed bands, etc. An example antenna that can be used is a conventional cellular/GPS mounted antenna, available from taoglas (www.taoglas.com). In one aspect, besides the radio and antenna components, the transceiver unit 140 may further include processors, data storage units, communications interfaces, power supplies, and human interface devices.

The housing 110 can be a sealed structure and may include one or more housing parts such as a cover 115 and bottom portion or base plate 118. At least some of the housing parts may be made of a moldable plastic material. The housing can be formed from a robust, thick housing material. The material of the housing parts may be resistant against aggressive substances. The housing can be sealed to protect the radio, antenna, and other components contained within it. By using a seal of appropriate material, such as a graphite-containing material, a seal may additionally be provided against aggressive substances like gasoline or oil which may be present in an outside environment.

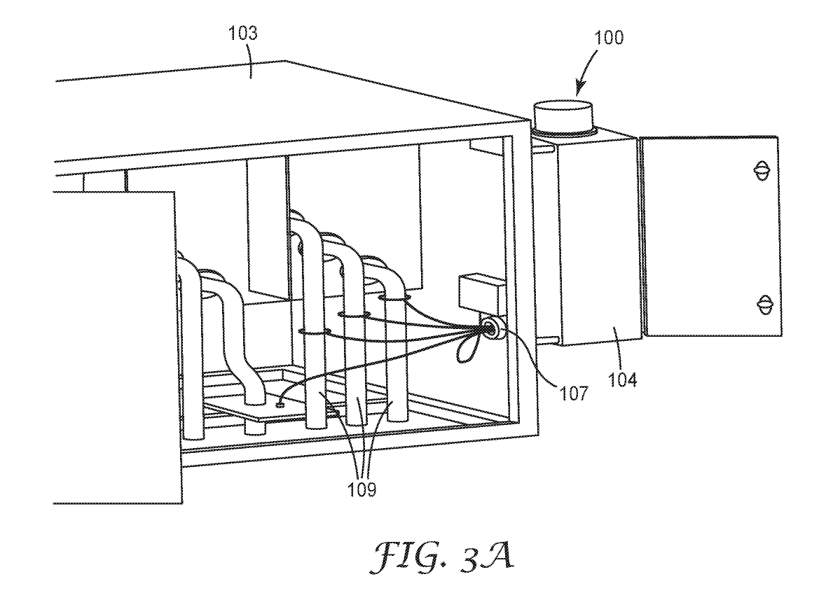

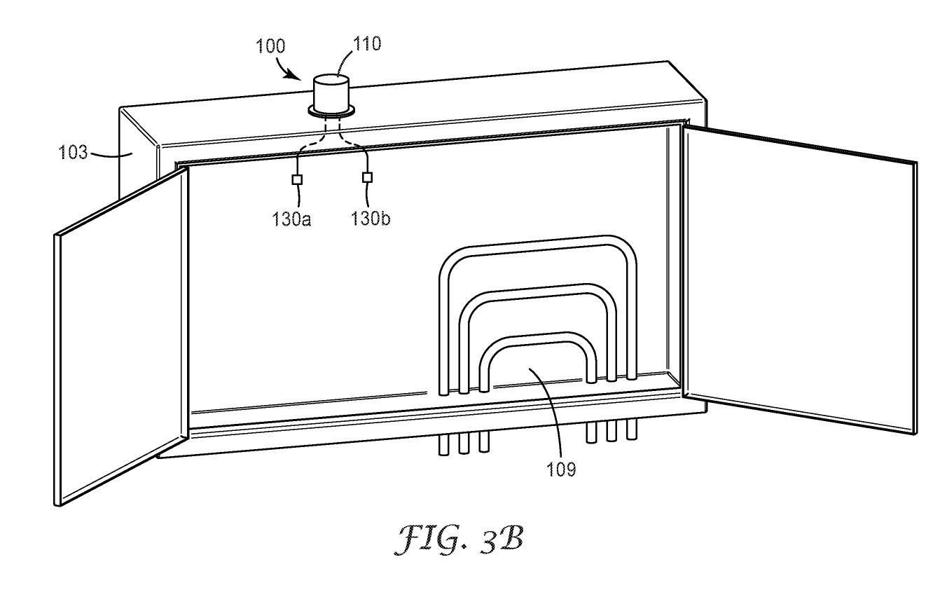

In addition, the base plate 118 can be further configured to attach to a cabinet, such as shown in FIG. 3A, where the data communication system 100 is mounted onto a separate mounting box 104 disposed on a cabinet 103. Alternatively, as shown in FIG. 3B, the data communication system 100 can be mounted directly onto the cabinet 103. In an alternative aspect, housing 110 can be constructed as a radio frequency transparent pavement marker made of high impact resistant resin that can be molded, machined, or cast. An example alternative construction is described in U.S. Pat. No. 6,551,014, incorporated by reference herein in its entirety. In this alternative aspect, the reflectivity of the marker can be modified to visually indicate a state of the equipment in the vault. For example, a blinking or non-blinking light can indicates normal/abnormal status. Further, a slowly blinking marker light can indicate caution, and/or a fast blinking light can indicate a dangerous condition. In this example, a liquid crystal filter can be mounted in front of the reflector, and the LC polarity can be modulated with a microprocessor. Alternatively, the internal light source, e.g., and LED, can be directly modulated.

The transceiver unit can be molded from a thermoplastic, machined, extruded, or it can be constructed from a conventional manufacturing process. Any surface or face (e.g., the top surface) of the transceiver unit can be additionally treated with a special coating, spray, laminate, reflective coating, or type of surface film (such as a microreplication process). This type of surface treatment allows the transceiver unit to be utilized in other applications, such as solar storage, lighting, heat absorber (energy), signage, ambient sensing, chemical sensing, and sound detection.

The electric or electronic components contained within the housing 110 can be active, passive, or both active and passive. In addition, the type of antenna design utilized can take into account the construction and materials used to form manhole cover 50. In a preferred aspect, manhole cover 50 comprises a standard, conventional manhole cover, as existing covers of various sizes and composition can be easily modified to fit the transceiver/antenna.

Thus, with this construction, if a monitoring device 130 senses a fault or problem condition, transceiver unit 140 can communicate real-time fault location information to a power utility network or SCADA system.

The data communication system further comprises a microcontroller or microprocessor 120 which can be disposed on a separate control electronics board 121, such as is shown in FIG. 1. The microcontroller or microprocessor 120 can comprise one or more chips or electronic devices that can provide operational control for the transceiver 140 and monitoring device or sensor 130. In addition, the controller chips can be configured to require only low power levels, on the order of less than 10 W. The data communication system can integrate a very low power (e.g., <3 W), highly computational chipset with time synchronized events and configurable sensors 130. In addition, in one aspect, the integration of GPS capabilities along with time synchronous events leads to finding problem conditions with early detection with set thresholds and algorithms for a variety of incipient applications/faults/degradation of key structural or utility components.

One or both of the microcontroller or microprocessor 120 and the monitoring device or sensor 130 can comprise appropriate circuits and/or electronics to read sensor data, analyze the data, aggregate the data, classify the data, infer conditions based on the data, and take action based on the data. In addition, the data communication system can provide a clock source (not shown) for event correlation.

In one alternative aspect of the invention, as shown in FIG. 4, a data communication system 100′ can include a sensor interface board or plate 132 that permits connection with one or more sensors and allows communication to the control electronics board. For example, a sensor 130 can be mounted to interface board or plate 132. Sensor 130 can be provided with a sensor dongle 133 that can extend the sensor head 137 to various places in an underground environment. Additional sensor interface receptacles 131b and 131c are also shown. Further, a sensor 134 can be coupled to the interface board or plate 132 and can include a sensor extension mechanism 135 to further extend the reach of the sensor head 137.

In an alternative aspect, an example structure that can be utilized to house at least some of the components of the transceiver is described in U.S. Pat. No. 8,135,352, incorporated by reference herein in its entirety.

In another aspect, multiple antennas can be embedded in the same housing 110 (or housing portion) allowing for multiple communications methods above ground. For example, WiFi and 4G antennas can be embedded in the same above ground antenna housing along with a GPS antenna to provide multiple network connections along with GPS positioning and timing information. A Bluetooth antenna can be embedded in the housing to provide local communications to personnel in close proximity to the transceiver/gateway unit. For example, a craft person driving over a transceiver/gateway unit could directly read the sensors in the vault below using Bluetooth. An RFID antenna can be embedded in the above ground housing to permit reading underground sensor data with an RFID reader.

In addition, a shield component 125 can be disposed between the antenna 147 and the control circuitry 120 to protect the electronics from antenna or external interference.

In another aspect, power can be provided to the components of the underground data communication system 100 through various means. In this aspect, transceiver 140 includes a large, primary battery that is rated for at least 12-15 years. The battery (not shown) can be mounted on the underside of the crcuit board 121. In this aspect, communications system 100 can be configured to conserve the power used by the transceiver 140 by operating on a periodic basis. For example, in addition to a, e.g., once-a-day status check, the sensor can be programmed to only send signals to the transceiver 140 when key, problematic events occur.

In a further alternative aspect, the underground enclosure can further include a wireless power transmitter mounted near the transceiver 140. The wireless power transmitter can wirelessly transmit power to the transceiver (via inductive coupling, such as near-field inductive coupling). For example, the wireless power transmitter can include a first (primary) inductor that couples with a second inductor located in the transceiver 140. The wireless power transmitter can be brought into close proximity to the transceiver 140 via a hinged support arm mounted within the underground enclosure. In one aspect, the wireless transmitter can be placed into an operational position where the distance to the transceiver 140 can be closer than about ⅓ wavelength of the carrier frequency used. Antenna positioning within the wireless power transmitter and transceiver can be further optimized depending on the conditions.

In a further aspect, solar panels can be employed for trickle powering the battery, an energy storage chip that can be mounted on the main circuit board, or other internal components. Alternatively, piezoelectric transducers can be utilized to convert the mechanical vibration found within the enclosure to electrical energy that can be stored in batteries or super capacitors. For example, a conventional piezoelectric transducer is available from Mide (www.mide.com). This type of additional energy storage can augment the life of the power source/primary battery included in system 100.

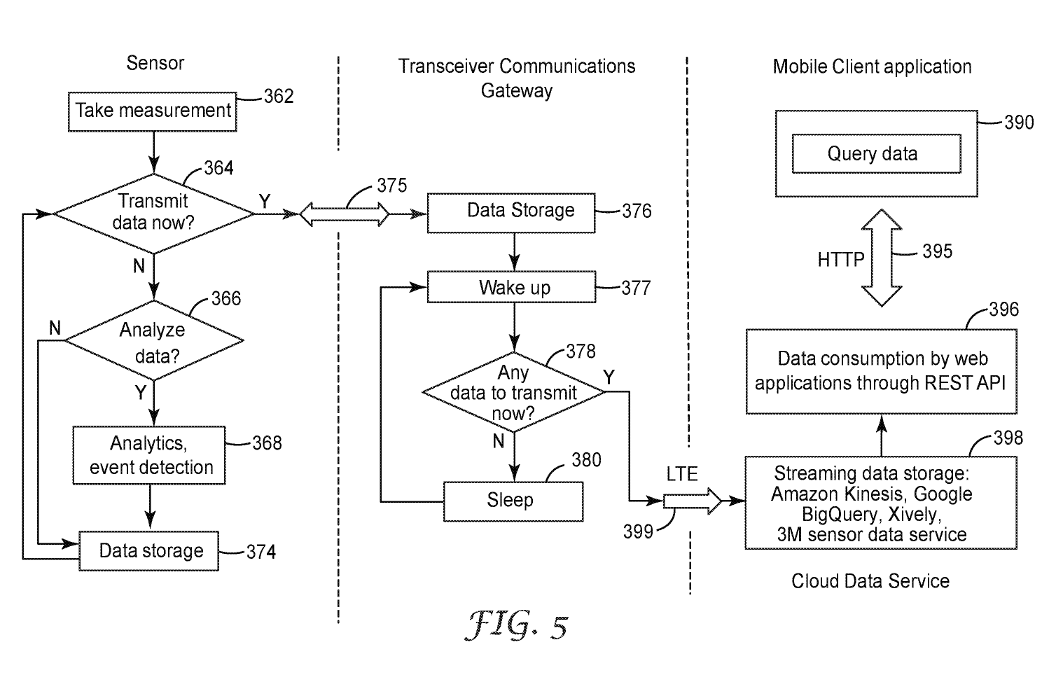

In further detail, FIG. 5 provides an example communications flowchart illustrating an example communication scheme involving the sensor, the transceiver and a network, such as a mobile client application. In the example of FIG. 5, a sensor measurement can be can be processed by the active sensor itself, depending on the type of sensor utilized. The sensor processes the measured signal by performing one or more modes of analysis. In this example, the sensor can record a measurement (step 362) of a real time condition. The sensor determines whether to communicate formatted data (step 364) to the transceiver. If no, in step 366, the sensor determines if it should analyze the data. If the data is not analyzed, it is sent to data storage (step 374). If the data is to be analyzed, analytics and/or event detection can be performed (step 368). Based on the analysis the data is stored in memory (step 374).

If data is to be communicated outside of the enclosure, formatted/measured/analyzed data is communicated to the transceiver (either wirelessly or through a communications line) in step 375. In this aspect, the transceiver 140 is typically kept in sleep mode (step 380) and will be signaled to wake up (step 377) upon receiving a data signal from the sensor that is stored in data storage (step 376). Otherwise, in this aspect, the transceiver wakes up at a predetermined time.

A decision is made to transmit data in step 378. If data is not sent, the transceiver can be placed back in sleep mode (step 380). A data package is formatted and is transmitted from the transceiver via a standard or private telecommunications protocol (step 399) to a cloud data service or SCADA (step 398). The entity receiving the data (e.g., operations center or service vehicle) can then act on the notification from the transceiver/gateway unit. For example, a WAN receiver (e.g., a mobile receiver unit, such as a service technician having a communication device loaded with the appropriate App, or the operations center of the service provider) can receive the packeted data from the transceiver, query, decrypt and/or decode the information (in step 390). This information can be communicated via the internet or network communications (step 395) from/to the cloud data service or SCADA (398), with data consumption by web applications (step 396). For example, in step 396, a representational state transfer can take place, thereby creating, reading, updating, and/or deleting information on a server.

In one aspect, this type of communication system allows a utility company to accurately pinpoint an event or condition location, thus saving the time and expense of entering and physically inspecting a multitude of vault locations within the grid. Further, this communication system allows a utility to communicate directly to a particular enclosure and/or transceiver to reconfigure or update system settings, tables, thresholds for power and environmental sensing.

Similar to that discussed above, in alternative aspects, as shown in FIGS. 3A and 3B, a data communication system 100 can be implemented in an above ground environment, such as where low, medium, or high voltage cables 109 enter from the underground and are exposed in the grade level equipment. Sensor wires can enter/exit the cabinet 103 into or out of separate mounting box 104 via port 107. Data communication system 100, which can include one or more sensors, such as sensors 130a and 130b, can be mounted directly to the cabinet 103 or to the separate mounting box 104. For example, grade-level or above ground devices that can utilize one or more of these communication systems include, e.g., power or distribution transformers, motors, switch gear, capacitor banks, and generators. In addition, one or more of these communication systems can be implemented in self-monitoring applications such as bridges, overpasses, vehicle and sign monitoring, subways, dams, tunnels, and buildings. The monitoring devices themselves can require very low power computational capabilities driven by event occurrence, identification, location, and action taken via a self powered unit. Further, the integration of GPS capabilities along with time synch events leads to finding key problems with early detection with set thresholds and algorithms for a variety of incipient applications/faults/degradation of key structural or utility components. Another variable is the non-destructive mechanical construction which would have the ability to be utilized in fairly hazardous applications.

The data communication system can be configured as a modular or upgradeable unit. Such a modular unit can allow for dongle or separate module attachment via one or more interface ports. As shown in FIG. 4, multiple sensors are connected to the data communication system 100′. Such a configuration can allow for the monitoring of a variety of additional environmental sensors, which can detect parameters such as gas, water, vibration, temperature, oxygen-levels, etc.). The dongle or connector blocks can also include a plug-n-play electrical circuit for automatically identifying and recognizing the inserted sensing module (and automatically set up proper synchronization, timing, and other appropriate communication conditions).

In one aspect, this type of communication system allows a utility company to accurately pinpoint an underground event, thus saving the time and expense of entering and physically inspecting a multitude of vault locations within the grid. In addition, performing the appropriate local actions can quickly restore service to customers and prevent further damage to the grid itself.

The present invention has now been described with reference to several individual embodiments. The foregoing detailed description has been given for clarity of understanding only. No unnecessary limitations are to be understood or taken from it. All references to right, left, front, rear, up and down as well as references to directions are exemplary only and do not limit the claimed invention. It will be apparent to those persons skilled in the art that many changes can be made in the embodiments described without departing from the scope of the invention. Thus, the scope of the present invention should not be limited to the details and structures described herein, but rather by the structures described by the language of the claims, and the equivalents of those structures.

1. A data communication system, comprising:
a housing mountable to an enclosure, the housing including a transceiver configured to communicate with a network outside of the enclosure, a monitoring device attachable to the housing that provides data related to a real-time condition within the enclosure, control electronics to control sensor data communication via the transceiver, and a power source to power the transceiver on an at least intermittent basis.

2. The data communication system of claim 1, wherein the monitoring device comprises a sensor.

3. The data communication system of claim 2, wherein the sensor detects at least one of: temperature, combustible materials or byproducts of combustion, mechanical strain, mechanical movement, humidity, soil condition, pressure, hazardous atmosphere, liquid flow, leakage, component end-of-life or lifetime, personnel presence, physical state, light level, and vibration.

4. The data communication system of claim 1, wherein the transceiver unit includes a hardened above ground antenna.

5. The data communication system of claim 4, wherein the transceiver unit further includes a radio.

6. The data communication system of claim 1, wherein the transceiver is configured to send aggregated information upstream to another aggregation node or cloud server above ground.

7. The data communication system of claim 6, wherein the aggregated data comprises one or more of periodic status notification and asynchronous alarm notification.

8. The data communication system of claim 1, wherein the transceiver is configured to respond to messages sent to it by an upstream aggregation node or cloud.

9. The data communication system of claim 1, wherein the enclosure comprises an underground enclosure.

10. The data communication system of claim 9, wherein the housing is mountable to an entrance port to the underground enclosure, wherein the entrance port comprises a manhole cover and a ring portion to receive the manhole cover.

11. The data communication system of claim 9, wherein the transceiver housing is substantially flush with a top surface of the manhole cover.

12. The data communication system of claim 1, wherein the enclosure comprises a ground level or above ground enclosure.

13. The data communication system of claim 1, further comprising a plurality of interface ports configured to connect to one or more environmental sensors.

14. The data communication system of claim 13, wherein at least one interface port provides for dongle attachment.

15. The data communication system of claim 1, wherein the power source comprises one of a battery, a ferroelectric device, a super capacitor, a power harvester, and a photovoltaic device.

16. The data communication system of claim 1, for monitoring at least one of power or distribution transformers, motors, switch gear, capacitor banks, and generators.
